(19) United States
(12) Patent Application Publication
(10) Pub. No.: US 2006/0106895 A1
(43) Pub. Date: May 18, 2006

(54) Method and subsystem for performing metadata cleanup for replication topologies

(75) Inventors: Philip Austin Vaughn, Redmond, WA (US); Ram Pratap Singh, Sammamish, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 10/987,737

(22) Filed: Nov. 12, 2004

(51) Int. Cl. G06F 12/00; G06F 17/30

(52) U.S. Cl. 707/204

(57) ABSTRACT

A method of exchanging data between a database and distribution nodes in a multimode replication environment includes defining data stored in a database to be exchanged for replication and using database data having at least two subsets of data. The subsets are distinct and have no overlap. At least one subset is distributed to only one node. Other subsets may be distributed to other nodes. The node receiving the distinct, non-shared subset of database data is permitted to change the data based on a creation, modification, or deletion of elements in the data subset. The changed subset data is returned to the data base and the database stores the changed data without performing conflict checks or distribution list calculations as performed in prior art systems.

### REFERENCE TO RELATED APPLICATIONS

This application is a continuation-in-part application from U.S. patent application Ser. No. ______, filed Oct. 29, 2004, entitled “Method And System For Performing Subset Computation For Replication Topologies”, attorney reference number MSFT-4457/309442.01, which is incorporated herein by reference in its entirety.

### FIELD OF THE INVENTION

This invention relates in general to the field of database management. More particularly, this invention relates to database management in a simplified spoke and hub architecture.

### BACKGROUND OF THE INVENTION

A distributed database is a relational database whose information may be replicated out to multiple user databases. Although dispersed, a distributed database system manages and controls the entire database as a single collection of data. Distributed databases often get updates from multiple users while in operation. In normal operation, a distributed database is accessed by a user and a portion of the information is changed. The changes are saved, and the changes are then distributed out to some or all of multiple other users for their reference. Often, a single user may utilize only a small portion of the database. Accordingly, only that small portion is passed out to the single user for his specific review. However, other users may also request information containing exactly the same information, so multiple copies of the information are replicated and passed out to the requesting users for their review. Conflicts can arise in a distributed database system as a result of moving a data set or image to and from a users database. For example, a conflict can arise due to multiple updates on the same data set image from multiple users. The distributed database management system must resolve the multiple user changes in order to keep a properly updated and consistent database core. An example of such a replication system can be a database in a commercial environment that is used for the sale of items.

In a sales use database, one user can access information concerning a product, sell one of the products and change the quantity available while another user may be adding quantity to the data representing a newly received shipment or a return. In such instances, there may be conflict when either user saves his information back to the central database because of the multiple incoming conflicting changes on the data. Consequently, change data received by the database from the multiple users must be resolved before being entered back into the database. Often this change data is stored as metadata and can become very large. In addition, the database, after making a fully resolved change, is required to inform other users of that same portion of data that the information has changed. This often involves a significant amount of time in the computation of a distribution list for the updated information as well as the time required to actually distribute the updated information to the multiple interested destinations.

Modern distributed databases accommodate metadata storage, conflict resolution and update distribution requirements with a general purpose type of solution. The general purpose solution accommodates the situation where multiple users can access the same portion of the database, store metadata, resolve conflicts, determine distribution lists, and disseminate changes to multiple users regardless of whether multiple users have accessed the data or not. In other words, the general purpose solution is currently the one size fits all solution regardless of the functionality needed of the database. However, there are some database uses which do not require the computational overhead of the general purpose solution and can use an optimized solution for a more well-defined set of use requirements.

In a one user per data set replication topology, filtering or sub-setting data in a database management system can be expensive in computation intensity and corresponding speed and complexity. It is increasingly common to only want access to a small subset of the backend database. It is also not uncommon to perceive a need for a one user per data subset operational environment. This requirement is particularly common in sales force automation, field force automation, and customer relations management applications. It is observed that no computationally optimized solution exists for a database whose requirements allow only one user per data subset of a database.

Thus, there is a need for a database management method and system which optimizes the single user per data portion of database information. Such a specific solution can introduce efficiencies into database management for a restricted set of database applications. The present invention addresses the aforementioned needs and solves them with additional advantages as expressed herein.

### SUMMARY OF THE INVENTION

Aspects of the invention includes a method for efficiently incorporating changes across users in a hub and spoke topology where the partitioning schema creates discrete, non-overlapping partitions or data subsets. This implementation allows for increased performance and scalability of the replication system overall while avoiding the requirement present in prior art systems of resolving conflicts between different users and calculation of a distribution list upon modified partition or subset return from the user. This is possible because of the restriction that only one user obtains any one partition or subset of the database data and therefore no conflicts exist between other users.

An embodiment of the invention includes a system performing a method including the steps of defining data stored in a database to be exchanged for replication, using database data having at least two subsets of data, distributing from the database the first subset of data to a first node, changing at least one data element of the distributed first subset of data, and sending the changed first subset of data back to the database. In storing the data into the database, the calculation of a distribution list and a conflict check between other nodes is avoided. Additionally, conflict resolution metadata held by the database may be deleted.

### BRIEF DESCRIPTION OF THE DRAWINGS

The foregoing summary, as well as the following detailed description of exemplary embodiments, is better understood when read in conjunction with the appended drawings. For the purpose of illustrating embodiments of the invention, there is shown in the drawings exemplary constructions of the invention; however, the invention is not limited to the specific methods and instrumentalities disclosed. In the drawings:

FIG. 1 is a block diagram of a system involving aspects of the invention;

FIG. 2 is a flow diagram of an embodiment of the method of the invention; and

FIG. 3 is a block diagram showing an exemplary computing environment in which aspects of the invention may be implemented.

### DETAILED DESCRIPTION OF ILLUSTRATIVE EMBODIMENTS

Overview

In an embodiment of the invention, a database having a single user per node is optimized. Nodes are envisioned as being discrete as are subsets of information from the database. This well-partitioned, one-subset-per-user restricted system allows optimizations that can yield efficiencies in computation, speed and complexity.

### Exemplary Embodiments of the Invention

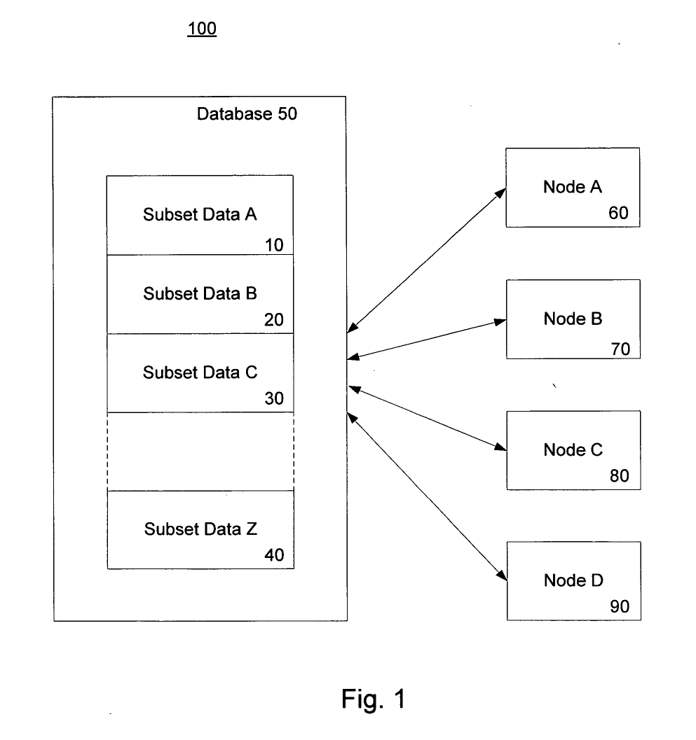

FIG. 1 is a depiction of a system 100 which encompasses a hub and spoke topology for a replication system servicing a database. In some applications, the information in a database 50 may be logically partitioned into tables or data subsets 10, 20, 30, 40. External leaf nodes 60, 70, 80, 90 may access the data subsets 10-40 exclusively for node-specific purposes. In the context of the present invention, each node 60-90 can be restricted to have access to one or more discrete, unshared subsets of data. Those unshared subsets are then not sent to any other node. Therefore there is no duplication or overlap of subset data between nodes; only one node may have a specific subset of the data.

One example of a single leaf node per table or data subset topology can be found in the operation of a company in the overnight package delivery business. Using this example, the driver of a package delivery truck would receive specific delivery packages she would deliver for a certain day. Those specific delivery packages are different from, and do not overlap with, the delivery packages assigned to another driver in a different delivery truck operated by the same company. In this configuration, it is unreasonable for another driver to update the status of a specific package during the day if the package physically does not exist on their truck. Data update conflicts are only possible between locations where data is shared. In this example the data is the status of a specific package on a specific delivery truck and the package is not shared among different tucks. In this example instance, the truck driver eventually updates all of his package delivery information when she transmits the updated data from a data logging device or truck to a central server input port such as a receiver at the package delivery business headquarters. It is possible that a data conflict can result between the headquarters data and the download data that a delivery truck node provides on a certain package. But, there can be no conflict between a second delivery truck and a first delivery truck on a single package because a single package, or subset of data, resides only on one truck. Consequently, additional filter computation, such as determining which nodes (trucks) on the central server require updated information concerning the specific package status, can be bypassed. This is true because the other nodes on the system, the other trucks delivering other packages, do not necessarily need the updated status of a specific package on another tuck. Only the central server need keep a record of all of the packages being delivered on a certain day.

In one embodiment of the example, a conflict check between updated package status data and the central server database data is avoided because the only copy of the specific package data that is checked out is the copy that is on the truck that carries the updated package status. Hence a conflict check between the database and the updated package status is unnecessary.

As a result of these conditions, there is no need to resolve conflicting information, stored as metadata, between nodes and there is no need to compute a distribution list for updated information being downloaded into the central server. Since there is no distribution needed other than the node which already has modified the data, then no distribution list need be calculated. Correspondingly, there is not need to evaluate specific filters common in distributed database management systems that function to detect and resolve node-to-node conflicts or calculate distribution lists for changed data. This overall approach allows a greater efficiency in the operation of database updates because conflict resolution between nodes is not needed, the storage space required for change metadata is greatly reduced, and a distribution list for nodes which share the same information need not be calculated as it has been predetermined that other replicas of the subset data in the topology do not need to receive updated row information. This allows for the benefits of data filtering reduction without introducing the extra overhead typically associated with the replication technology in a multiple node system. An additional benefit is that change metadata associated with a specific subset of data may be deleted after the database has saved that subset. This further reduces the amount of memory needed to store large quantities of otherwise constantly accumulating change metadata.

While the instance of a package delivery business environment is exemplary, it is not the only utility. Other implementations of a single user per data set restriction can use the current invention to advantage. Such implementation include, but are not limited to, sales force automation databases, field force automation databases, customer relation management databases, and other single user document or data manipulation database systems.

In a more generalized multi-node replication data embodiment, data can be updated from one node to another without performing conflict checking between the two nodes and without calculating a distribution list where the updated data is to be sent. This can even occur where one of the nodes is not the primary database as long as the node that distributes the well-partitioned data to a first and/or second node restricts that distribution such that there is no overlap between downstream nodes. In this manner, no conflicts between nodes with multiple copies of the well-partitioned data can occur and aspects of the invention may be implemented.

In one embodiment of the invention, the well-known general purpose solution to mange multiple users and conflicting change data described previously may be augmented by the present invention as a mode of operation that may be selected within a database management system. This inventive mode allows a less computationally intensive method of sending changes to a server. This mode may be invoked in a multiple user system where there are one or more nodes that exclusively have distinct, non-overlapping subset data. In such an environment, the one or more nodes may have non-overlapping subsets with respect to all other nodes. Thus the precondition of non-overlapping data subsets can be satisfied such that aspects of the invention, such as the avoidance of multi-node conflict checks and the calculation of multi-node distribution lists can be achieved to realize greater efficiency in transferring change data from the one or more replication nodes.

In the general purpose solution mentioned above, where a node receives data from a central node such that there is some overlap between this data and data received by another node, then the process represented by the following pseudo-code occurs when this node replicates its changes to the central node.

```
Enumerate changes to user data from node not yet seen by central node.
If changes exist
{
  Check whether central node made changes to same data
  If both nodes made changes, not yet seen by other node
  {
    Conflict detected.
    Resolve conflict.
  }
  If no conflict, or if result of conflict is to apply change to central node
  {
    Apply the change to the user data at the central node.
    Create or update the change tracking data which will be used to
replicate changes to other nodes.
    Evaluate specified filters for changed data, and persist results as
partition mapping for changes.
  }
}
```

In one aspect of the present invention, each node receives distinct, well-partitioned data from the central node. In this case, the process represented by the following pseudo-code occurs when this node replicates its changes to the central node.

```
Enumerate changes to user data from node not yet seen by central node.
If changes exist
{
  Check whether central node made changes to same data
  If both nodes made changes, not yet seen by other node
  {
    Conflict detected.
    Resolve conflict.
  }
  If no conflict, or if result of conflict is to apply change to central node
  {
    Apply the change to the user data at the central node.
    Update the change tracking data
    Skip the evaluation of filters
    Explicitly map all changes to partition identifier of node that is
uploading changes.
  }
}
```

One aspect of the present invention is to skip the evaluation of filters. As a matter of record keeping, all changes may preferably be explicitly mapped to a partition identifier of the node that is uploading changes. The evaluation of filters in the presence of complex filters can be time and resource intensive, and skipping it can result in significant performance improvements. In another aspect of the invention, the change metadata relied upon to perform conflict resolution between a central node and a spoke node in a spoke and hub type topology may be deleted after a change is recorded in the central node. The change metadata may be deleted because the hub and spoke system of the invention allows only a single spoke node to check-out data and change it. A second spoke node is unable to check-out the same information as the first spoke node. Accordingly, central hub node metadata exists along with the first spoke node metadata to resolve a difference only between those two nodes. After any conflict is resolved between the hub and spoke nodes, the metadata may be deleted and valuable memory space may be preserved.

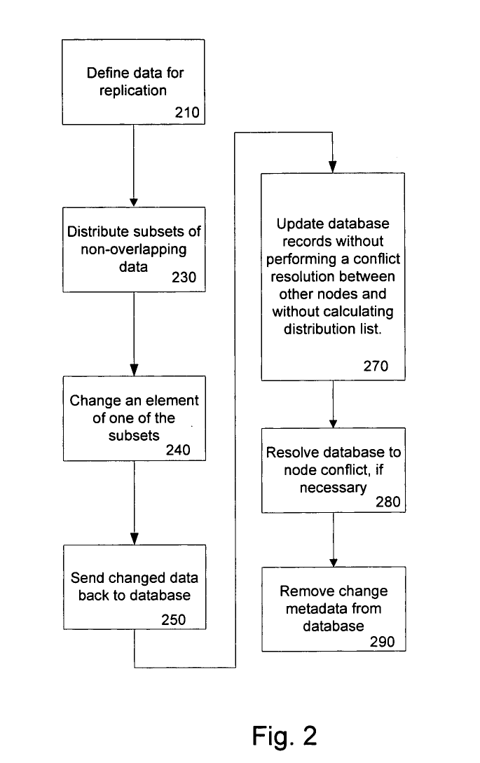

FIG. 2 depicts a flow diagram of the method of aspects of the invention. Initially, the data to be replicated is identified (step 210). This identification can be an action where a block of data of interest in a database, such as one or more tables or a group of rows, is identified as an area of interest for replication. Although not a necessary part of the method, the identified data may be naturally partitioned into subsets. This may result from the character of the data such that one user node may request a specific set of data and a second user node may request a different set of data; the data having different characteristics that are useful to only one user, but not both. In an aspect of the present invention, there is no overlap between an element in one subset of the data and an element in a separate subset of the data. The subsets essentially have no intersection. The partitioned data is then distributed to at least one node (step 230). Here, a node can be any physical or logical entity that can download at least one subset of the data in order to read, use or change the subset. As an aspect of the invention, if more than one node is provided with data subsets, then any one data subset can be changed by only one node.

Once the node has a downloaded and discrete copy of a subset of the data, the node can change an element of the data (step 240). The change can encompass a modification, addition, deletion, or creation of an element within the subset. In one embodiment, a creation of a new subset may be permitted. Once the change has occurred, the node can send the changed subset data back to the database (step 250). The return of the subset data can occur synchronously or asynchronously. A synchronous return can be, among other possibilities, an event that occurs at a particular time. An asynchronous return can be an event that occurs at any time convenient to the node and/or database.

Once the changed subset data is returned to the database management system, the changes to the data subset can be saved to the database without first calculating a distribution list for the changed subset data (step 270). In addition, a conflict resolution calculation resulting from differences between distribution nodes may be avoided since no other node is involved in the use if the subset data. As a result of the node downloading and changing an element in the subset, change metadata was generated and stored in the database. This change metadata may be used for conflict check and resolution between the database and the distribution node (step 280), but only if a conflict is detected. After any conflict between the database and the node is resolved and the changed data stored in the database, the change metadata is removed from the database (step 290). In some instances, it may not be necessary to perform a conflict resolution between the database and the node that received the subset of data. But, if a conflict is apparent, the change metadata may be used to perform the conflict resolution (step 280) before the metadata is removed (step 290). The cleanup of metadata following the storage of the changed data into the database is an improvement over existing general purpose solutions for distributed databases that must maintain their metadata for longer periods of time.

Exemplary Computing Device

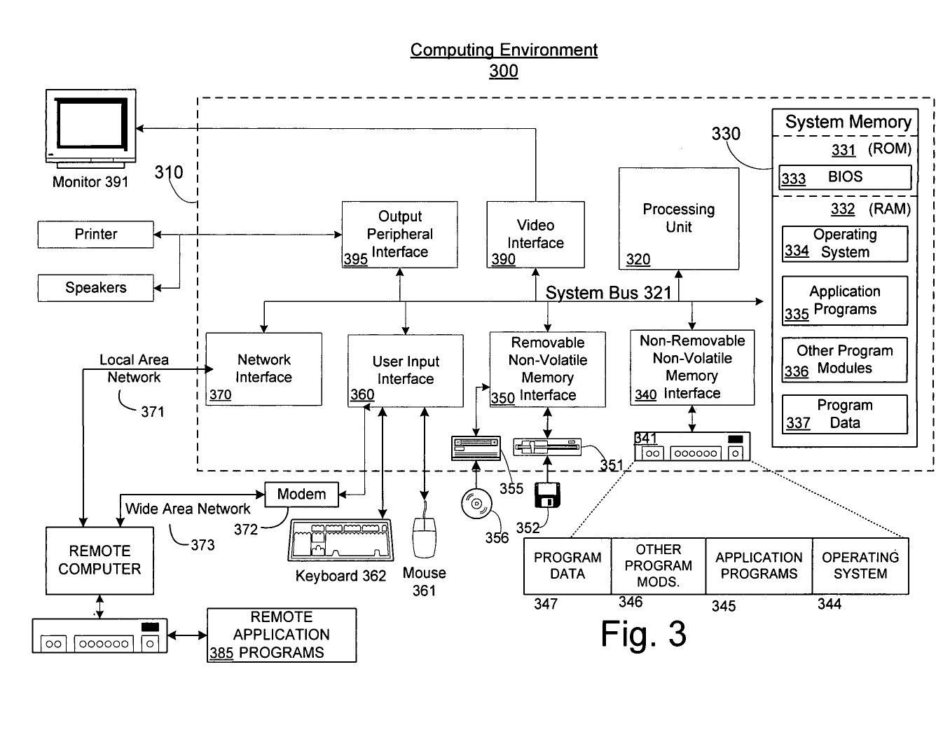

FIG. 3 and the following discussion are intended to provide a brief general description of a suitable computing environment in which embodiments of the invention may be implemented. While a general purpose computer is described below, this is but one single processor example, and embodiments of the invention with multiple processors may be implemented with other computing devices, such as a client having network/bus interoperability and interaction. Thus, embodiments of the invention may be implemented in an environment of networked hosted services in which very little or minimal client resources are implicated, e.g., a networked environment in which the client device serves merely as an interface to the network/bus, such as an object placed in an appliance, or other computing devices and objects as well. In essence, anywhere that data may be stored or from which data may be retrieved is a desirable, or suitable, environment for operation.

Although not required, embodiments of the invention can also be implemented via an operating system, for use by a developer of services for a device or object, and/or included within application software. Software may be described in the general context of computer-executable instructions, such as program modules, being executed by one or more computers, such as client workstations, servers or other devices. Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that various embodiments of the invention may be practiced with other computer configurations. Other well known computing systems, environments, and/or configurations that may be suitable for use include, but are not limited to, personal computers (PCs), automated teller machines, server computers, hand-held or laptop devices, multi-processor systems, microprocessor-based systems, programmable consumer electronics, network PCs, appliances, lights, environmental control elements, minicomputers, mainframe computers and the like. Embodiments of the invention may also be practiced in distributed computing environments where tasks are performed by remote processing devices that are linked through a communications network/bus or other data transmission medium. In a distributed computing environment, program modules may be located in both local and remote computer storage media including memory storage devices and client nodes may in turn behave as server nodes.

FIG. 3 thus illustrates an example of a suitable computing system environment 300 in which the embodiments of the invention may be implemented, although as made clear above, the computing system environment 300 is only one example of a suitable computing environment and is not intended to suggest any limitation as to the scope of use or functionality of an embodiment of the invention. Neither should the computing environment 300 be interpreted as having any dependency or requirement relating to any one or combination of components illustrated in the exemplary operating environment 300.

With reference to FIG. 3, an exemplary system for implementing an embodiment of the invention includes a general purpose computing device in the form of a computer system 310. Components of computer system 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer system 310 typically includes a variety of computer readable media. Computer readable media can be any available media that can be accessed by computer system 310 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, Random Access Memory (RAM), Read Only Memory (ROM), Electrically Erasable Programmable Read Only Memory (EEPROM), flash memory or other memory technology, Compact Disk Read Only Memory (CDROM), compact disc-rewritable (CDRW), digital versatile disks (DVD) or other optical disk storage, magnetic cassettes, magnetic tape, magnetic disk storage or other magnetic storage devices, or any other medium which can be used to store the desired information and which can accessed by computer system 310. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer system 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337.

The computer system 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356, such as a CD ROM, CDRW, DVD, or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3 provide storage of computer readable instructions, data structures, program modules and other data for the computer system 310. In FIG. 3, for example, hard disk drive 341 is illustrated as storing operating system 344, application programs 345, other program modules 346, and program data 347. Note that these components can either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer system 310 through input devices such as a keyboard 362 and pointing device 361, commonly referred to as a mouse, trackball or touch pad. Other input devices (not shown) may include a microphone, joystick, game pad, satellite dish, scanner, or the like. These and other input devices are often connected to the processing unit 320 through a user input interface 360 that is coupled to the system bus 321, but may be connected by other interface and bus structures, such as a parallel port, game port or a universal serial bus (USB). A monitor 391 or other type of display device is also connected to the system bus 321 via an interface, such as a video interface 390, which may in turn communicate with video memory (not shown). In addition to monitor 391, computer systems may also include other peripheral output devices such as speakers 397 and printer 396, which may be connected through an output peripheral interface 395.

The computer system 310 may operate in a networked or distributed environment using logical connections to one or more remote computers, such as a remote computer 380. The remote computer 380 may be a personal computer, a server, a router, a network PC, a peer device or other common network node, and typically includes many or all of the elements described above relative to the computer system 310, although only a memory storage device 381 has been illustrated in FIG. 3. The logical connections depicted in FIG. 3 include a local area network (LAN) 371 and a wide area network (WAN) 373, but may also include other networks/buses. Such networking environments are commonplace in homes, offices, enterprise-wide computer networks, intranets and the Internet.

When used in a LAN networking environment, the computer system 310 is connected to the LAN 371 through a network interface or adapter 370. When used in a WAN networking environment, the computer system 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer system 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

Various distributed computing frameworks have been and are being developed in light of the convergence of personal computing and the Internet. Individuals and business users alike are provided with a seamlessly interoperable and Web-enabled interface for applications and computing devices, making computing activities increasingly Web browser or network-oriented.

For example, MICROSOFT®'s .NET™ platform, available from Microsoft Corporation, includes servers, building-block services, such as Web-based data storage, and downloadable device software. While exemplary embodiments herein are described in connection with software residing on a computing device, one or more portions of an embodiment of the invention may also be implemented via an operating system, application programming interface (API) or a “middle man” object between any of a coprocessor, a display device and a requesting object, such that operation may be performed by, supported in or accessed via all of .NET™'s languages and services, and in other distributed computing frameworks as well.

As mentioned above, while exemplary embodiments of the invention have been described in connection with various computing devices and network architectures, the underlying concepts may be applied to any computing device or system in which it is desirable to implement a discrete, non-overlapped data set per user replication feature. Thus, the methods and systems described in connection with embodiments of the present invention may be applied to a variety of applications and devices. While exemplary programming languages, names and examples are chosen herein as representative of various choices, these languages, names and examples are not intended to be limiting. One of ordinary skill in the art will appreciate that there are numerous ways of providing object code that achieves the same, similar or equivalent systems and methods achieved by embodiments of the invention.

The various techniques described herein may be implemented in connection with hardware or software or, where appropriate, with a combination of both. Thus, the methods and apparatus of the invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device will generally include a processor, a storage medium readable by the processor (including volatile and non-volatile memory and/or storage elements), at least one input device, and at least one output device. One or more programs that may utilize the signal processing services of an embodiment of the present invention, e.g., through the use of a data processing API or the like, are preferably implemented in a high level procedural or object oriented programming language to communicate with a computer. However, the program(s) can be implemented in assembly or machine language, if desired. In any case, the language may be a compiled or interpreted language, and combined with hardware implementations.

While aspects of the present invention has been described in connection with the preferred embodiments of the various figures, it is to be understood that other similar embodiments may be used or modifications and additions may be made to the described embodiment for performing the same function of the present invention without deviating therefrom. Furthermore, it should be emphasized that a variety of computer platforms, including handheld device operating systems and other application specific operating systems are contemplated, especially as the number of wireless networked devices continues to proliferate. Therefore, the claimed invention should not be limited to any single embodiment, but rather should be construed in breadth and scope in accordance with the appended claims.

What is claimed:

1. A method of exchanging data between a database and distribution nodes in a multimode replication environment, the method comprising:
defining data stored in a database to be exchanged for replication;
distributing, from the database, the first subset of data to a first node and distributing a second subset of data to a second node, wherein overlap of elements in the first subset and the second subset is absent;
changing at least one data element of the distributed first subset of data;
sending the changed first subset of data back to the database wherein the changed first subset of data is stored in the database without calculating a distribution list for the first subset of data; and
removing metadata concerning the changed first subset of data from the database.

2. The method of claim 1, further comprising resolving a conflict between the database and the first node before removing the metadata.

3. The method of claim 1, wherein a conflict check between the changed first subset of data and the second subset of data is avoided.

4. The method of claim 1, further comprising:
changing at least one element of the distributed second subset of data;
sending the changed second subset of data back to the database to be stored without calculating a distribution list for the second subset of data; and
removing metadata concerning the changed second subset of data from the database.

5. The method of claim 4 wherein a conflict check between the changed second subset of data and the first subset of data is avoided.

6. The method of claim 4, further comprising resolving a conflict between the database and the second node before removing the metadata.

7. The method of claim 1, wherein changing at least one element comprises one of creating, modifying and deleting the at least one element.

8. The method of claim 1, further comprising mapping changes of the first subset of data to an identifier of the first node.

9. A system for exchanging data between nodes and a database, the system comprising:
a database;
at least two nodes, the nodes capable of downloading subsets of the database;
means for executing instructions, the instructions performing a method comprising:
defining data stored in a database to be exchanged for replication;
distributing, from the database, the first subset of data to a first node and
distributing a second subset of data to a second node, wherein overlap of elements in the first subset and the second subset is absent;
changing at least one data element of the distributed first subset of data;
sending the changed first subset of data back to the database to be stored without calculating a distribution list for the first subset of data; and
removing metadata concerning the changed first subset of data from the database.

10. The system of claim 9, further comprising the method step of resolving a conflict between the database and the first node before removing the metadata.

11. The system of claim 9, wherein the method further comprises avoiding performing a conflict check between the changed first subset of data and the second subset of data before saving the changed first subset into the database.

12. The system of claim 9, wherein the method further comprises:
changing at least one element of the distributed second subset of data; and
sending the changed second subset of data back to the database for storage without calculating a distribution list for the second subset of data; and
removing metadata concerning the changed second subset of data from the database.

13. The system of claim 12, further comprising the method step of resolving a conflict between the database and the second node before removing the metadata.

14. The system of claim 12, wherein the method further comprises avoiding performing a conflict check between the changed second subset of data and the first subset of data before saving the changed second subset into the database.

15. The system of claim 12, wherein the method further comprises mapping changes of the first subset of data to an identifier of the first node.

16. A computer-readable medium having computer-executable instructions for performing a method for exchanging data between a database and distribution nodes, the method comprising:
defining data stored in a database to be exchanged for replication;
distributing, from the database, the first subset of data to a first node and distributing a second subset of data to a second node, wherein overlap of elements in the first subset and the second subset is absent;
changing at least one data element of the distributed first subset of data;
sending the changed first subset of data back to the database wherein the changed first subset of data is stored in the database without calculating a distribution list for the first subset of data; and
removing metadata concerning the changed first subset of data from the database.

17. The computer-readable medium of claim 16, further comprising the method step of resolving a conflict between the database and the first node before removing the metadata.

18. The computer-readable medium of claim 16, wherein a conflict check between the changed first subset of data and the second subset of data is avoided.

19. The computer-readable medium of claim 16, further comprising:
changing at least one element of the distributed second subset of data;
sending the changed second subset of data back to the database for storage without calculating a distribution list for the second subset of data; and
removing metadata concerning the changed second subset of data from the database.

20. The computer-readable medium of claim 19, further comprising the method step of resolving a conflict between the database and the second node before removing the metadata.

21. The computer-readable medium of claim 16, wherein a conflict check between the changed second subset of data and the first subset of data is avoided.

22. The computer-readable medium of claim 16, wherein changing at least one element comprises one of creating, modifying and deleting the at least one element.

23. The computer-readable medium of claim 16, wherein the method further comprises mapping changes of the first subset of data to an identifier of the first node.
